(19) United States
(12) Patent Application Publication
(10) Pub. No.: US 2013/0268478 A1
(43) Pub. Date: Oct. 10, 2013

(54) System and method for correct and effective transaction execution in a data center system by implementing FIFO-grouping in a data store

(71) Applicant: Yechiel Fefer, Haifa (IL)

(72) Inventor: Yechiel Fefer, Haifa (IL)

(73) Assignee: Gigaspaces Ltd., Hertzlia (IL)

(21) Appl. No.: 13/741,813

(22) Filed: Jan. 15, 2013

Related U.S. Application Data
(60) Provisional application No. 61/588,191, filed on Jan. 19, 2012.

(51) Int. Cl. G06F 17/30

(52) U.S. Cl. CPC G06F 17/30563
USPC 707/602

(57) ABSTRACT

A data center is a computing environment focusing on the execution of data transactions for corporations and organizations. The data center has the capability of running many execution threads in parallel.

However, a major portion of such transactions require in order processing. Guaranteeing this requirement may mean not running the data center at it's full capacity as some of it's threads may be stopped to guarantee a correct operation.

The present invention will enable running the data center at fuller processing capacity while guaranteeing correctness.

For a data store of a certain corporation selection criteria will be used, The selection criteria will determine what subset of the data will be used and also what are the basic elements—a FIFO will be designated for each such element using the indices, and the execution will be allowed only at the FIFO order and only one thread will be able to deal with a FIFO.

The other threads will be able to deal with other FIFOs.

This non provisional patent application claims benefit of the filing date of provisional application 61/588,191 filed on Jan. 19, 2012, as a priority date for this application

### BACKGROUND

In high throughput OLTP systems where partial ordering of incoming data is essential to the correctness of the processing, but total ordering of the data incurs a large processing time overhead. Examples for this kind of system are financial order management systems, which have to process large amounts of orders, but in most cases require ordering of incoming orders only between orders for a specific security or stock, but not across the entire set of orders.

### Prior Art

1 A Queue based systems. In queue based system a queue (or queues) are created in advance using a queue factory. In order to process a queue the identification of the queue has to be rendered to the process. This means less flexibility and also a waste of processing time. Queue based systems lack the capabilities of a general-purpose data store which is served for various organizational processing.

2. Data base systems. An order-by query can be rendered to a DB which supports a proper query mechanism, and it can return elements in FIFO order if a timestamp is part of the data elements. This means massive sorting of data. Such queries will provide ordering but will lack the enabling capability of randomly picking ordered subsets which is currently free for execution and assigning an execution thread exclusively for each ordered subset, while allowing other non-related (non FIFO) processes to access the data.

The invention will arrange the data elements automatically in FIFOs—each FIFO will have in it all the elements requiring ordering. It will be executed in order and exclusively, while allowing non-FIFO parallel processing to access all data elements which belong to the currently executing FIFO except the first element of the FIFO.

### BRIEF DESCRIPTION OF THE DRAWINGS

FIG. 1 shows the main components of the system.

FIG. 2 is a description of the system at execution in run time

FIG. 3 is a flow chart for a data item

FIG. 4 is a flow chart of the execution task

FIG. 5 describes an execution thread flow chart.

FIG. 6 describes the handling of addition/update/removal or release from transaction of a data item in a data store.

FIG. 7. describes the structure of a FIFO-grouping enabled index in the data store which enables random between-groups processing.

FIG. 8. describes the structure of a compound FIFO-grouping enabled index in the data store which enables random between-groups processing.

### DETAILED DESCRIPTION

A data center is a very big computation and storage system. It is typically over the internet using cloud-based system. It is focused on processing very large number of data transactions for big organizations. These can be bank, car rental companies, brokerage firms. The transactions can be orders from customers or corporate initiated operations. For example, customer deposit and withdrawal orders on bank accounts or interest payments on the same account.

Each transaction is based on a data item, such as a bank account.

Some of the transactions need to be atomic—such as the deposit transaction.

Some of them need to be in order—for example, a customer deposit and withdrawal—a withdrawal may not be allowed if a deposit was not done.

The transaction itself may be simple—few operations or very complicated. The requirements of atomicity and in order will be the same.

A data center has a lot of storage and computation capacity.

There may be many processing cores, capable of running many threads in parallel, each is capable of running a transaction. It is important of course to allow the data center to run the required task at a high processing capacity when required.

The data center has a data store which supports FIFO-grouping. FIFO-grouping means the ability to derive FIFOs based on a group type. Each FIFO contains the data items with the same value of group type. For example—in bank-transaction records the group type may be the account number, so each FIFO is the bank-transaction records of the same account-number FIFO ordered. There is no global ordering between different FIFOs.

In a FIFO-grouping system each FIFO which is executed upon is exclusively handled by only one thread using a transaction. At the end of execution the thread removes the first element of the FIFO and commits the transaction. The FIFO is then free to be executed again by another (or same) thread which will handle its new first element. An execution thread may be configured to execute all elements of a FIFO before committing and freeing the FIFO.

A FIFO-grouping processing request will contain a selection criteria—it will contain the group-type and optional stipulation values for other fields of the data items related. For example in order to process bank-transaction records originated only from VISA cards the selection criteria will be group type of bank-account and bank-transaction-source=‘VISA’ which means process all FIFOs of bank-transactions by bank-account and only of bank-transaction data items having bank-transaction-source=‘VISA’.

A managing program will handle FIFO-grouping overall processing. The managing program will derive selection criteria from corporate criteria for the processing requested. For every selection criteria it will assign a task instance. The managing program will also deliver to the execution threads, via the tasks, information about new FIFOs that may be relevant as a result of data items addition/updates in the data store.

Each task will handle a certain selection criteria using execution threads that will be initiated by calling the OS or using a dynamic thread pool. The selection criteria will determine the FIFOs to be used. The execution threads are rendered the selection criteria+execution logic to perform. Each thread starts a transaction, locates a free FIFO using the indices or (in case of idle threads) information regarding new or freed FIFO rendered from the task, executes on the FIFO, remove the first element from the FIFO and commits the transaction on it.

Freed/new FIFOs are reported to idle execution threads via the task, enabling idle threads to be returned to the thread pool until work is available.

The FIFO-grouping-enabled indices enable the execution threads to locate and traverse the relevant FIFOs without building them and also enables in many cases random selection of FIFOs which contributes to processing load distribution, bottleneck reductions and fairness. For example—if the task is handling shipments, it will process the arrivals data items FIFO ordered by shipment number, the threads will be able to obtain arrival FIFOs distributed over the shipment-number range.

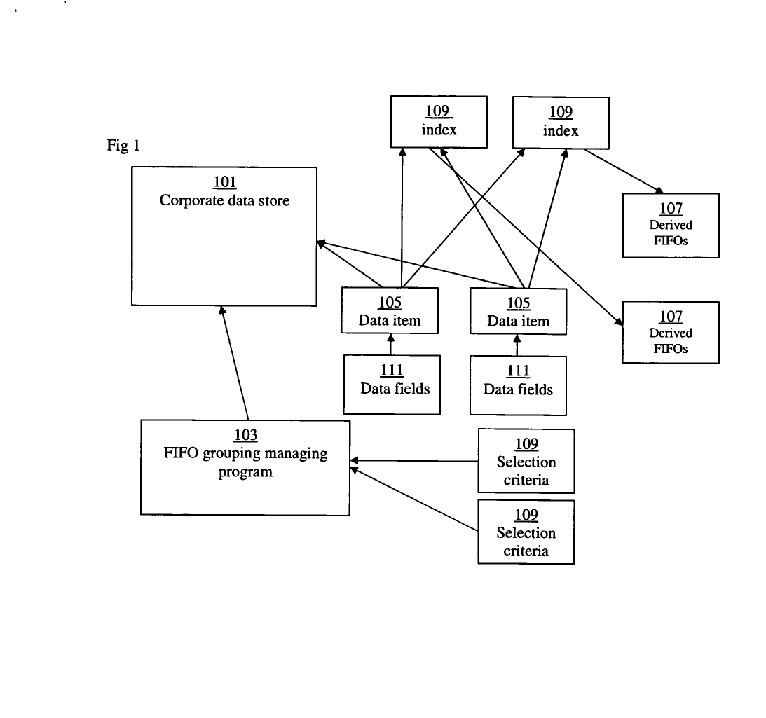

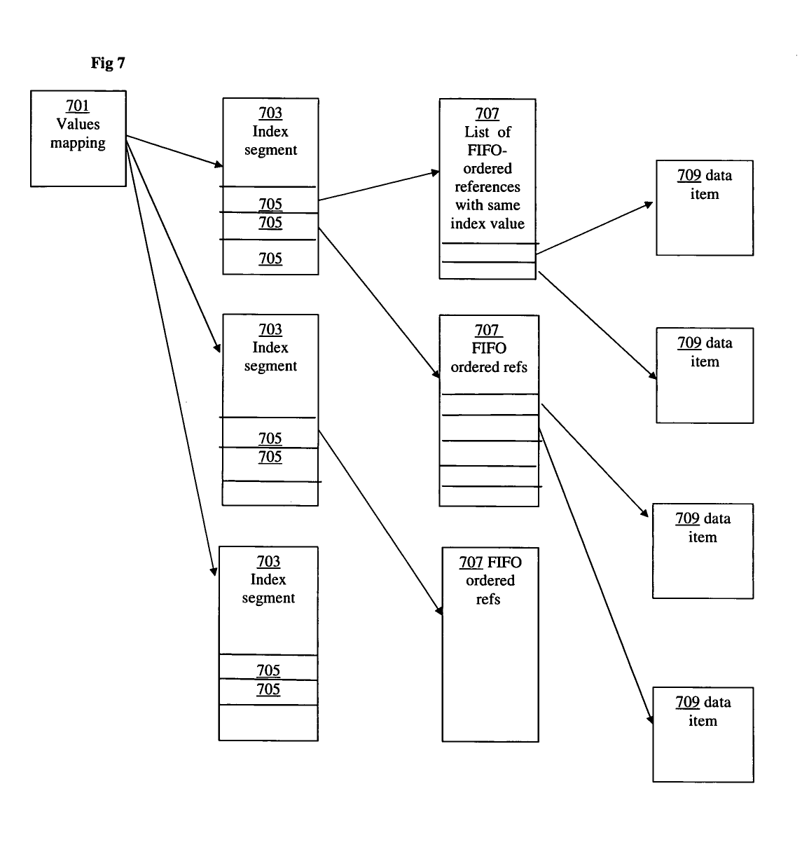

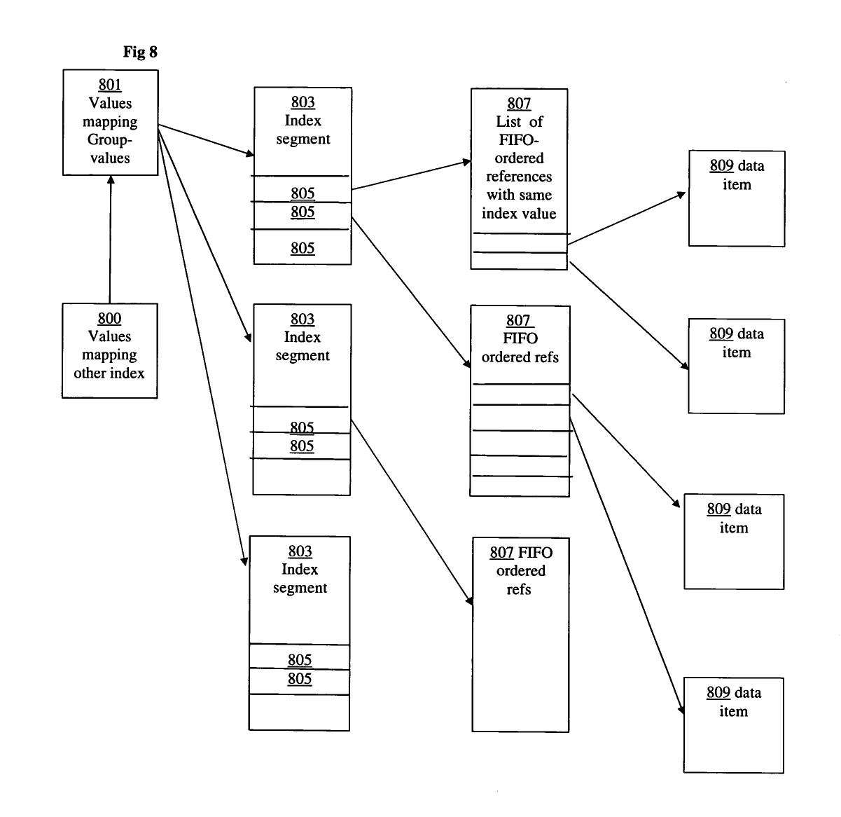

FIG. 1 shows the main components of the system. 101 is a corporate data store with FIFO grouping-enabled indices (see FIG. 7 and FIG. 8).

103 is the FIFO-grouping managing program which manages the FIFO-grouping processing tasks. 109 are selection criteria for FIFO-grouping processing (the selection criteria is rendered to the managing program at run time by the application requesting the FIFO-grouping processing). A selection criteria contains the group type to FIFO by (for example account-number in bank transaction data items) and possible stipulation on other data fields (for example transaction-source=ATM′).

105 are data items in the data store 111 are data value fields in the data items. 109 are FIFO-grouping enabled indices which enables the processing (see FIG. 7 and FIG. 8)

107 are the FIFOs pointed by the indices

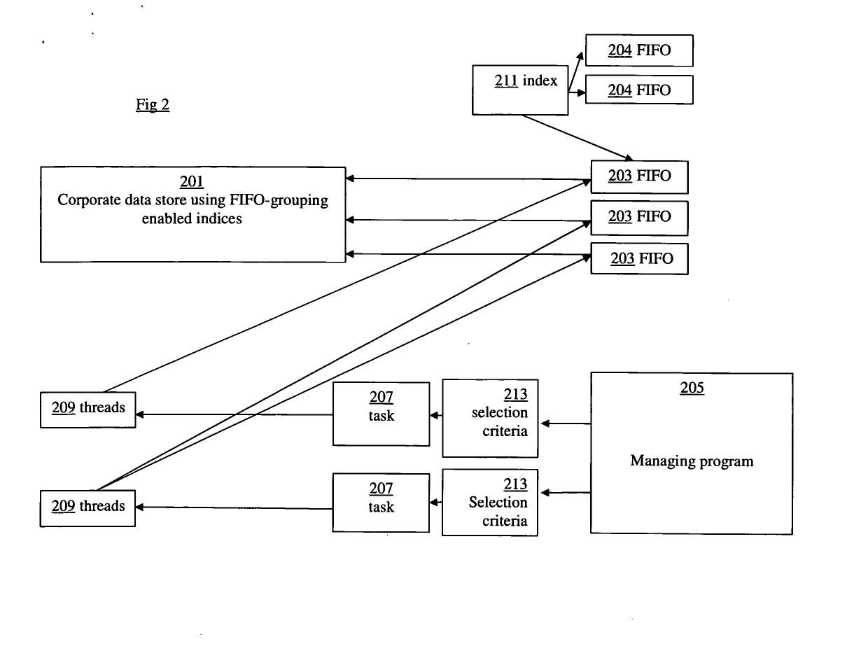

FIG. 2 describes the system at execution in run time.

201 is a corporate data store using FIFO grouping enabled indices (see FIG. 7 and FIG. 8) for the data items. The indices form FIFOs each such FIFO is the order per the specific index value (no global FIFO ordering maintained—only order per value)

203 are the FIFOs derived by the indices and are currently processed by the threads.

204 are the FIFOs derived by the indices and are currently free.

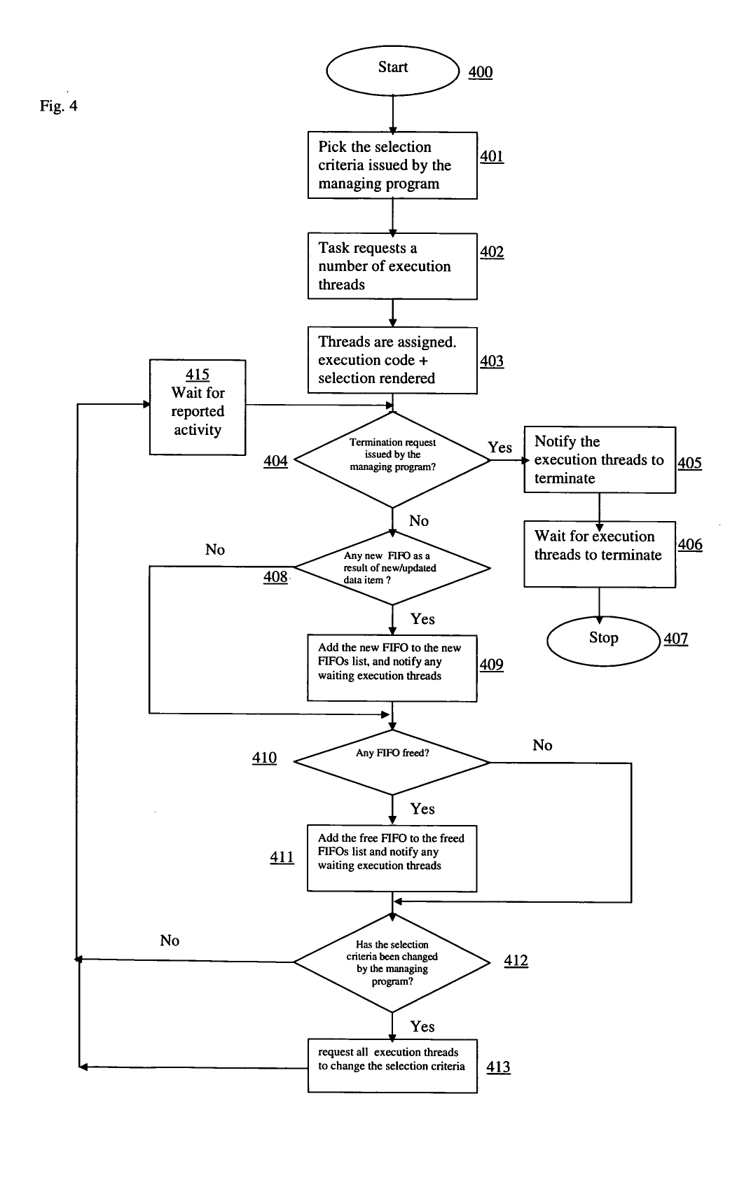

205 is the managing program responsible for the FIFO processing handling. The managing program creates tasks (207) for FIFO processing with a given selection criteria. 211 is the selection criteria rendered per task (see FIG. 4)

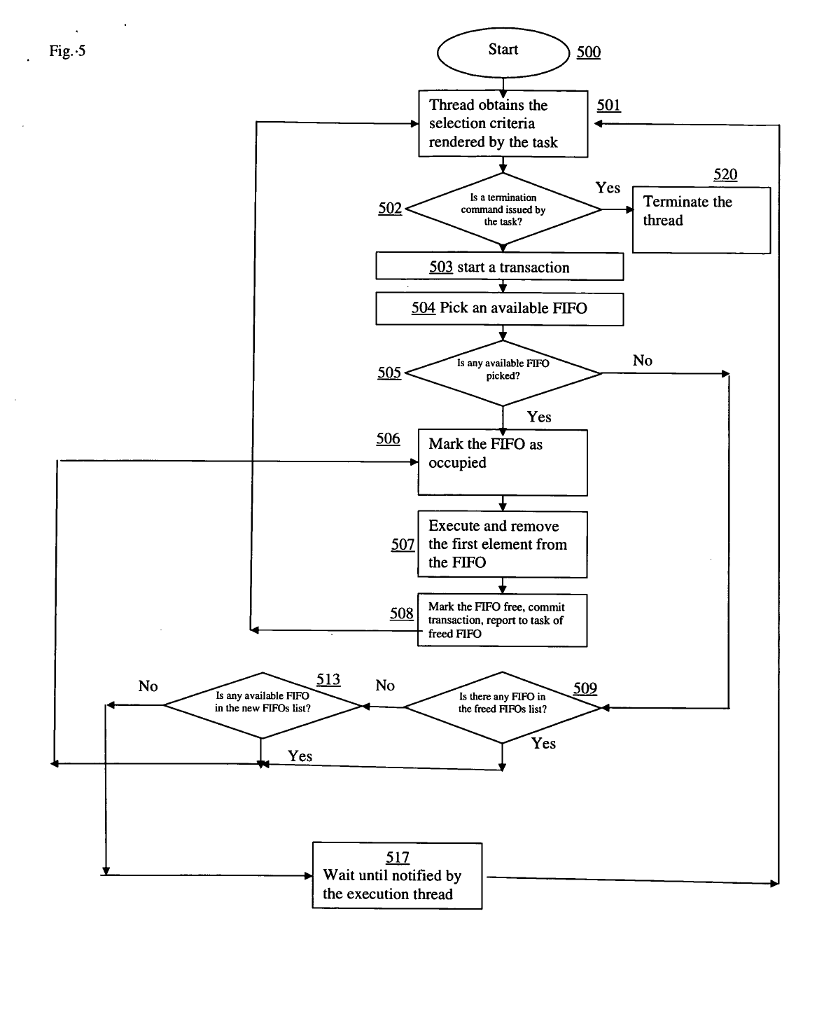

209 are the execution threads designated by each task, which perform the actual FIFO processing. Each thread is rendered the selection criteria which contains FIFO group type (for example by account# of bank transactions, by shipment-id of arrivals data etc′)+possible selection stipulations on other data fields. Also the execution logic to perform is rendered to the threads. The FIFOs are selected randomly in order to minimize bottle-necks maximize performance and act fairly (see FIG. 5). 211 is the index from which points at the FIFOs to process.

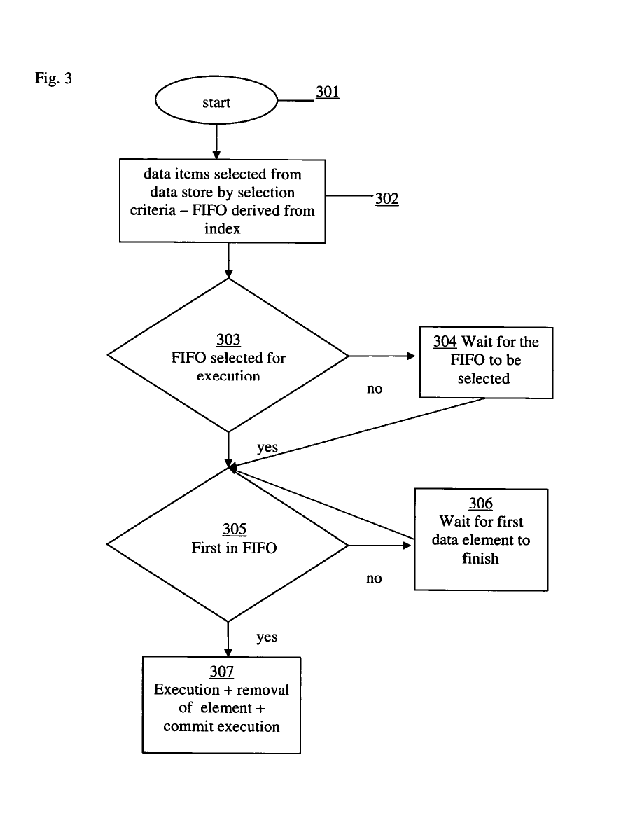

FIG. 3 describes the data item flow chart.

Step 301 is the start.

In Step 302 a data item selected from data store by selection criteria and is a part of a FIFO.

In Step 303 it will be asked if the FIFO (which the data item is part of) was selected to run

If the answer is NO it will go to step 304 where it will wait for the FIFO to be selected.

If the answer is yes it will go to step 305, where it will be asked if it is the first in the FIFO executing.

If the answer is NO it will go to step 306, where it will wait for the first data item to finish and be removed and then back to step 305.

If the answer is yes it will go to step 307 where it will be executed and removed from the FIFO.

FIG. 4 is a flow chart of the execution task. The execution task accepts selection criteria (i.e. group type and optional stipulations on data item fields) from the FIFO-grouping managing program and assigns the work to execution threads. The execution task also gets reported on FIFOs that are freed or new FIFOs in the data store that match the selection criteria as a result of new data items added to the data store.

Step 400 is a start.

In step 401 the selection criteria rendered by the managing program is made ready for the execution threads to use.

In step 402, the task will ask for a number of execution threads. Threads can be obtained from a dynamic thread-pool or from the operating-system.

In step 403 threads are assigned to this task.

In step 404 the task check if a termination request was issued by the managing program. If the answer is yes: the execution threads are notified to terminate (step 405) the task waits for all threads to terminate (step 406) and will stop (step 407)

In step 408 the task will ask if any new FIFOs where created as a result of an addition of a new data item. The task is notified on any addition/update of a data item matching the selection criteria. If the answer is yes step 409 is performed—the task will add the FIFO to its list of new FIFOs and notify any of its threads that are idle.

In step 410 the task will ask if any FIFO got freed. If the answer is yes step 411 is performed the FIFO is added to the freed FIFOs list and the waiting threads are notified.

In step 412 the task checks if the selection criteria was changed by the managing program. A selection criteria is composed of group type and optional values stipulations. (i.e. group type is account number, stipulation is bank-transaction source=‘VISA’), the values stipulation part may be altered by the managing program. In that case step 413 is performed the lists of new and freed FIFOs are cleared and all threads related to the task are notified on a new selection criteria.

In 415 the task waits for reported activities/requests (termination, selection-criteria change, possible new FIFOs creation, freed FIFOs) and goes to step 404 if such event occurs

FIG. 5 describes an execution thread flow chart.

In step 500 is the start.

The task requests a number of execution threads and renders the execution-logic code to the thread.

In step 501 the thread obtains the selection criteria which is composed of FIFO group type (i.e. account numbers, shipment numbers) to group by+optional values' stipulations rendered by the task.

In step 502 the thread checks if a termination is requested by the task. If yes it performs step 520 in which it terminates (in case of thread pool it returns to the pool).

In 503 the thread starts a processing transaction.

In 504 the thread tries to pick an available FIFO using the FIFO enabled indices and the FIFO-group type+the selection criteria stipulations (if rendered). FIFOs are selected randomly using the indices in order to minimize collisions and bottlenecks, maximize performance and apply fairness (see FIG. 7, FIG. 8 index structure). In 505 if no available FIFO was picked 509 is executed. If an available FIFO was picked 506 is executed.

In 506 the FIFO is marked occupied, marking the FIFO occupied is done atomically with testing its availability as free. In 507 the thread is executing the processing logic (rendered to it by the task) on the first FIFO element and removes it from the FIFO. Note that the first element is the first in the FIFO that matches the selection criteria (there can be several stipulations on the data items' field values in addition to the selected index. Elements that do not match are skipped. Processing a FIFO is done under a transaction and in 508 operation is committed and the FIFO marked as free and the thread reports execution termination+freed FIFO event to the task and goes to 501.

In 509 it is checked if any relevant FIFOs where reported as being freed, and the thread will to pick any of them. If no—it goes to 513. If yes it goes to 506 to execute on the FIFO

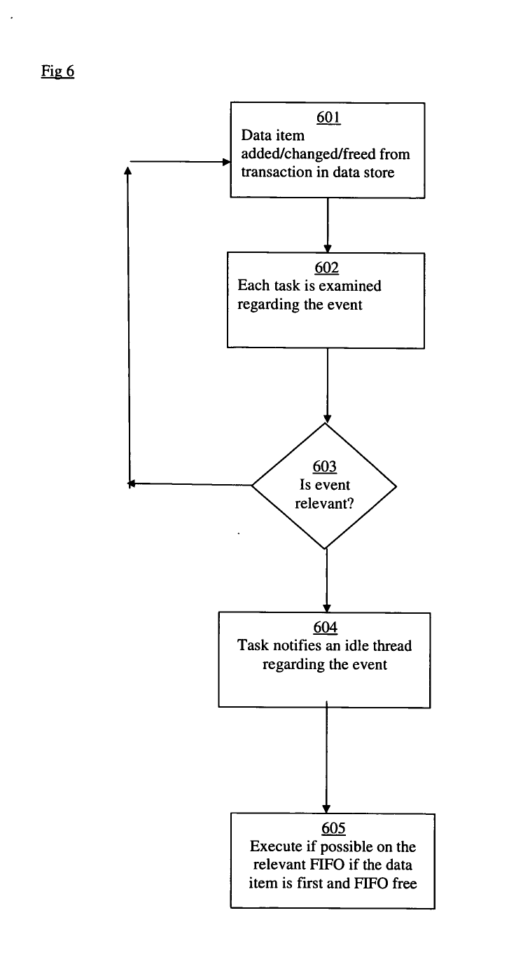

In 513 it is checked if any relevant FIFOs where reported as being added to the data store as a result of adding/updating a data item in the data store or releasing of a data item from a transaction (see FIG. 6), and try to pick any of them. If no—it goes to 517 where the thread wait for events. If yes it goes to 506 to execute on the FIFO

The above described method will guarantee that data items which need in order execution will be processed in order, while the available execution power can be used to process in parallel many data items which do not require execution ordering.

FIG. 6 describes the handling of addition/update/removal or release from transaction of a data item in a data store.

In 601 a data item is added/updated/removed or release from transaction.

In 602 and 603 the FIFO-grouping management program call each task which has idle threads waiting for work and its selection criteria match the data-item and renders the event info. In 604 an idle thread is notified regarding the event and in 606 the thread tries to operate on the related FIFO if relevant and free

FIG. 7 describes the structure of a FIFO-grouping enabled index in the data store which enables random between-groups processing.

701 is the value mapping which maps every required value into a reference to a list, those references reside within index segments. 2 data structures are used for mapping hash-based mapping and binary-tree mapping.

703 is an index segment which contains references to lists. 705 is a reference to a list which is a FIFO-ordered list of references (707) to data items which all have the same value for the described index. Note—if case of an empty selection criteria (i.e. contains only grouping type and no other stipulations on data item's fields values) or no index in the selection criteria (which is quite a common case) which means process all FIFOs according to the group type (example—process all bank transactions FIFO-grouped by account number) the execution threads will not use the mapping (701) but will directly and randomly traverse the segments. If an additional index value is used in the selection criteria the compound index of the additional index and the group type index will be used (see FIG. 8), example: process the bank transactions FIFO grouped by account—number and the bank-transaction-source field value=‘ATM’. If bank-transaction-source field is indexed the compound index of bank-transaction-source and account-number will be used as explained in FIG. 8.

707 is the FIFO ordered list of references to data items 709.

FIG. 8 describes the structure of a compound FIFO-grouping enabled index in the data store which enables random between-groups processing. The compound index is used in cases where the FIFO grouping selection criteria contains, in addition to the group type, other stipulations on the data item's fields which are indexed. In this case the system selects, from the list of stipulations, the compound index which has a minimal cardinality (points at the minimal number of data items). The compound index is composed of the index value used in the stipulation compound with the FIFO group-type index.

For example—It is requested to process the bank transactions data items FIFO-grouped by account-number and has stipulations of bank-transaction-source=‘ATM’ and bank-transaction-credit=‘VISA’. If both bank-transaction-source and bank-transaction-credit are indexed, and there are less data items with bank-transaction-source=‘ATM’ than with bank-transaction-credit=‘VISA’ the compound index of bank-transaction-source/account-number will be used.

800 is the value mapping from the first index (in our example—bank-transaction-source) when each value points at a mapping of the relevant values of the group value index. (in the example—account-number). The result is a FIFO grouping of the combination bank-transaction-source/account-number.

801 is the value mapping which maps every required value of the group-type index into a reference to a list, those references reside within index segments.

803 is an index segment which contains references to lists. 805 is a reference to a list which is a FIFO-ordered list of references (807) to data items which all have the same value for the described index.

807 is the FIFO ordered list of references to data items 809.

In case of processing all FIFOs grouped by the group type the relevant index segments can be scanned randomly by using the mapping of the non FIFO-group value index (800) and skipping the group-type index mapping (801). In the above example—bank-transaction-source=‘ATM’ value from map 800 will point at the segments which will contain all the FIFOs of the combination bank-transaction-source=‘ATM’ compound with any account-number.

1. A data center using FIFO-grouping enabled data store, running a number of tasks for a number of customers, where based on selection criteria, a subset of the corporate data items will be selected.

2. A data center as in claim 1, where FIFOs of data items will be established, with a FIFO per an group-type value as defined by the selection criteria.

3. A data center as in claim 2, where the FIFOs will be derived from the FIFO-grouping enabled indices.

4. A data center as in claim 3 where an available execution threads will be assigned per FIFO

5. A data center as in claim 4 where only one execution thread can be assigned to a certain FIFO.

6. A data center as in claim 5 where other execution threads can be assigned to FIFOs which are not being executed upon.

7. A data center as in claim 1 where the selection criteria can be changed from time to time.

8. A data center as in claim 6 where the execution is under a transaction per FIFO data element

9. A data center as in claim 6 where the first data element in a FIFO is being executed
